(19) United States
(12) Patent Application Publication
(10) Pub. No.: US 2003/0177072 A1
(43) Pub. Date: Sep. 18, 2003

(54) Internet-based grocery ordering system and method for providing drive-through customer pickup of grocery orders at multiple locations as selected by customer

(76) Inventor: Carlos Bared, Miami, FL (US)

Correspondence Address: GREENBERG TRAURIG, P.A., 1221 Brickell Avenue, Miami, FL, 33131, US

(21) Appl. No.: 10/385,564

(22) Filed: Mar. 11, 2003

Related U.S. Application Data
(60) Provisional application No. 60/363,617, filed on Mar. 12, 2002.

(51) Int. Cl. G06F 17/60

(52) U.S. Cl. 705/26

(57) ABSTRACT

The present invention is an Internet-based grocery ordering system and method for providing drive-through customer pick-up of grocery orders at multiple remote locations as selected by the customer. The system integrates front-end customer friendly drive-through markets with an online order management system and delivery of groceries from fulfillment centers to drive-through markets at locations designed by the ordering customer. The system includes consolidated purchasing, customized electronic ordering and cost effective logistics management software.

### PRIOR U.S. APPLICATION

This Specification is based on U.S. Provisional Application Serial No. 60/363,617 filed on Mar. 12, 2003. The inventor claims the benefit of Title 35, Section 119 of the U.S. Code based on said provisional application.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

A. Technical Field and Brief Summary

This invention relates to Internet-based systems for engaging in commerce. More particularly, the present invention is an Internet-based grocery ordering system and method for providing drive-through customer pick-up of grocery orders at multiple remote locations as selected by the customer. The present invention, in a preferred embodiment, uses a unique logistics approach that integrates front-end customer friendly drive-through markets with online order management system fulfillment centers and delivery of groceries from fulfillment centers to drive-through markets. Its back-end system includes consolidated purchasing, customized electronic ordering and cost effective logistics using existing and profitable dual purpose fulfillment centers acting both as traditional supermarkets as well as fulfillment centers to supply drive-through market off-line and online orders. Offline and online orders are fulfilled from the same supermarket fulfillment centers using delivery vehicles that deliver goods daily to stores on a preset store route.

B. Background

The Food Marketing Institute reported that in 1999, consumers made an average of 2.2 trips per week to the supermarket, including a weekly stock-up trip and one or more fill-in trips. The fill-in trips are used to satisfy shopper needs for milk, meat, and other perishables as well as staples that were forgotten on the previous stock-up trip. Grocery shoppers spend 45 minutes to an hour on the weekly stock-up trip and from 25 to 30 minutes on the more frequent fill-in trips. Despite larger stores offering wider selections, many consumers are unhappy about having to spend an hour and a half looking for parking, walking to the store, navigating the aisles, and waiting in slow moving checkout lines, especially when most purchase the same items week after week.

Accordingly, supermarket grocery shopping has become a time-consuming chore. A University of Michigan study of consumer attitudes ranked supermarket shopping as the second least-liked chore, just behind cleaning the house. For busy shoppers, especially working women, shopping for repetitive stock-up items is a disliked chore and annoying problem. Of the approximately 104 million Americans who are considered primary shoppers for themselves or their families, 77 percent are women, 66 percent of who are now employed outside the home. The growing demand for more convenience is therefore partially accredited to the rising percentage of dual income households. Addressing this consumer need represents a business opportunity of great value to the innovator. There is a vast potential to satisfy consumer demand for groceries through new technologies and delivery systems.

The supermarket industry has been carefully watching the major online grocery retailers, which are attempting to significantly improve the grocery shopping experience on a more cost-effective basis. Some traditional supermarkets such as Kroger, Publix, Albertson's, Hannaford, Safeway, Tesco and Arnold have entered this area through alliances or are slowly rolling out their own operations.

Online Grocery Retailing

With the growth of the Internet, businesses have begun establishing online systems for transacting business. The online grocery market is growing fast but still hasn't achieved high penetration due to the slowness of supermarkets to enter e-commerce and the costs and investments required to support home delivery.

While Internet based home shopping systems allow a home shopping customer a great deal of flexibility, Internet based home shopping systems, particularly Internet based grocery shopping systems, suffer from various disadvantages, specifically with regard to pick-up and delivery options. For example, when a customer visits a grocery store and makes grocery purchases, the customer is able to evaluate the contents of their shopping cart and make subsequent grocery purchases that will not either overflow the cart or total-up to an unmanageable weight. A customer will adjust the scope of their shopping trip by visually inspecting the shopping cart and making purchase decisions accordingly. In the case Internet grocery shopping, customers need to determine the size and weight of the goods being placed into a “virtual shopping cart.” Since the capacity of a virtual shopping cart is unlimited, a customer may well order an amount of merchandise which exceeds the customer's available space to store it. The system must also be able to judge whether the goods with the different environmental storage requirements being ordered can fit into the available refrigerator space, freezer space, and the like. In addition to providing such weights and measures information, an Internet based home shopping system should be able to categorize purchased items according to their environmental storage requirements such that a customer is able to prepare sufficient space for their receipt. By using this type of information, items can be appropriately packaged and stored in an appropriate environment while awaiting the customer's arrival for pick-up.

Prior art methods fail to address and resolve the specific combination of needs and problems associated with making a true drive-through pickup of an online grocery order, without having to get out of one's vehicle, in an efficient, effective and commercially viable manner possible and with the ability to add to the online order on the spot at the pick-up location. The system and method of the present invention addresses these needs.

### SUMMARY OF THE INVENTION

The present invention is Internet-based grocery ordering system and method providing drive-through customer pickup of grocery orders at multiple remote locations as selected by the customer.

The present invention has been designed to eliminate the inefficiencies associated with the weekly re-stocking trip to the supermarket. By integrating the benefits of customized online ordering with true drive-through (without having to exit one's vehicle) express market pick-up store, the present invention provides an integrated fulfillment system created to deliver value and superior service to today's highly mobile and time-starved consumers. The system provides graphical representations of the items available for purchase, enabling purchasers to judge product item size.

The system includes a user-side personal computer system configured for Internet access and communicating with the system server at the system end. The system end server is configured to host an Internet access application program and includes an Internet communication interface, a main processing unit and a mass storage device. One or more databases are stored in the mass storage device, including a searchable grocery product database with data representing item identification, item price and graphical representations of each as well as a grocery purchase order transaction database and a customer database. The database further includes an environmental storage metric which identifies the environment suitable for storing the corresponding item of merchandise.

In one aspect of the invention, a consumer accesses the system over an Internet connection and selects various items of merchandise for purchase from a menu or menus provided for such purpose. As items are selected for purchase, an application program opens and maintains a transaction log file including means for summing merchandise item information metrics, including the item identification and price.

In yet an additional aspect of the invention, items comprising an electronic order are categorized into a virtual shopping cart which is displayed to the customer over the display monitor of the home personal computer system.

The users preferably contract with an Internet service provider for general Internet access and have a suitable Internet browser program on their computer system.

The databases are stored in a large capacity mass storage device, such as a hard disk drive, or might alternatively be stored in a large capacity RAM or other alternative mass storage medium. Regardless of its configuration, the mass storage device hosts a number of purpose-built databases and files useful for implementation of the system of the present invention. Particular databases and files include the production information files, a multiplicity of transaction log files, and optionally, a customer database which includes demographic, personal preference, personal profile saved shopping lists and other information specific to each particular customer. In cases where the mass storage device is configured to include a customer user database, each particular customer's data record is preferably identified by and associated with a unique customer identification number, termed customer ID. Each customer's ID number identifies that customer and enables the system to identify a virtual shopping basket and its associated transaction log file with that particular customer as well as allowing access to that particular customer's data record from the network server's mass storage unit.

The system allows family shoppers to pick up their weekly stock-up groceries ordered online in less than 3 minutes in an exemplary embodiment, in their neighborhoods, without leaving the car. The system provides customers with control and flexibility on what they order, how and when they pay, and where and when their grocery orders are fulfilled.

At the system website customers designate the specific drive-through express market pick-up store where they will pick up their orders; select a convenient four-hour pick-up time window; fill their shopping carts; and place their orders online. Using the System's online tools such as personalized “shopping carts,” “frequent purchases” checklists, and automatic “new product suggestions” that are customized to each customer's shopping profile, customers can complete their online purchases in 10 minutes or less. Customers can use their credit cards to charge their purchases at the system's virtual store for even quicker checkout time at the express market pick-up stores. Customers that prefer not to use their credit cards online also have the option of paying with cash, check or debit/credit cards at the time they pick up their orders.

Shoppers immediately receive an order confirmation, via e-mail, that includes the order number, location, and their selected pick-up time information. Copies of the order are simultaneously received electronically at the express market pick-up store designated by the customer, as well as at the system fulfillment center, where picking tickets are generated. Customer orders are packed at the fulfillment center and delivered to the various express market pick-up store locations via temperature-controlled trucks running on fixed-scheduled routes.

When customers drive up to their neighborhood express market pick-up store, their orders are quickly retrieved, placed in the trunk/cargo area of their vehicles without the customer getting out of his/her vehicle, providing true drive through pick-up service, and they drive off in typically under three minutes. Consumers will value the 30 to 60 minutes saved each week.

Orders are fully guaranteed. If any item is not entirely to the customer's satisfaction, it can be returned for a replacement or a full refund at the neighborhood express market pick-up store. If customers forget to order items online they can always supplement their orders from the express market pick-up store's local inventory of hundreds of popular grocery items.

The system's solution is simple and much more efficient than the current models—no restless consumers waiting at home for their orders and no consumers frustrated from having to find parking and wait in long checkout lines.

The present invention is also a method for providing drive-through customer pick-up of grocery orders at multiple remote locations as selected by the customer, comprising the following steps: Providing an Internet website accessible by customers and including a searchable grocery product database and a grocery ordering transaction server and database through which customers accessing said database can search for and select for purchase grocery items and can search for and select one or more drive through pick-up stores and dates and times for customer pick-up of grocery orders placed through said website, processing customer grocery orders placed through said website by transmitting same to one or more grocery order fulfillment centers where grocery orders are packaged and loaded on to delivery vehicles based on the environmental storage requirements applicable to the ordered products and the designated drive through pick-up store location specified by the customer in said order, delivering grocery product orders from said fulfillment centers to the drive-through pick-up store location(s) designated by the ordering customer in advance of said customer's designated pick-up date and time, and loading the ordered groceries onto said customer's vehicle after said customer arrives at said designated pick-up store location and has paid for the ordered groceries.

### BRIEF DESCRIPTION OF THE DRAWINGS

All figures represent a preferred embodiment, but other alternate embodiments are within the scope of the present invention.

FIG. 1 is a diagram of the basic system architecture of the system of the present invention.

FIG. 2 depicts a sample user system login screen.

FIG. 3 depicts a sample system home screen.

FIG. 4 depicts a sample express pickup location search screen.

FIG. 5 depicts a sample pickup store location selection and scheduling screen.

FIG. 6 depicts a sample pickup store location selection and scheduling screen depicting alternate pickup times.

FIG. 7 depicts a sample product information screen, depicting breakfast cereals.

FIG. 8 depicts a sample product information screen depicting a selection of cereals and the purchase price subtotal for the selected items.

FIG. 9 depicts a sample shopping cart screen.

FIG. 10 depicts a sample load a saved shopping cart screen.

FIG. 11 depicts a sample save a shopping cart screen.

FIG. 12 depicts a sample frequent purchases screen.

FIGS. 13a-b depict a sample system information tour screen.

FIG. 14 depicts a sample how it works screen.

FIG. 15 depicts a sample corporate information screen.

FIGS. 16a-d depict a sample privacy policy screen.

FIG. 17 depicts a sample system feedback submission screen.

FIG. 18 depicts a sample shopping cart contents review screen.

FIG. 19 depicts a sample checkout screen, showing the customer's mailing address input screen.

FIGS. 20a-b depict a sample purchase order completion and payment information screen.

FIG. 21 depicts a sample order confirmation screen.

FIG. 22 depicts a sample user registration screen.

### DESCRIPTION OF A PREFERRED EMBODIMENT

The present invention is an Internet-based grocery ordering system for providing drive-through customer pick-up of grocery orders at multiple remote locations as selected by the customer, comprising a customer-side computer configured for Internet access to communicate with the system server, a system server providing an Internet communications interface with customers, further comprising a main processing unit and a mass storage device containing a searchable product database, and a grocery purchase order transaction server and database for online grocery order intake and processing, a grocery order fulfillment center communicating with said system server to receive and process customer orders and having one or more order fulfillment management software applications to maximize fulfillment efficiency and grocery product inventory management software, one or more drive-through stores located at locations remote from said fulfillment center which are available for customers to select as the pick-up point for their grocery order, means for delivering ordered products from said fulfillment center to said customer-designated drive-through market, and means for loading the ordered groceries onto said customer's vehicle after said customer arrives at said designated pick-up store location.

System Architecture

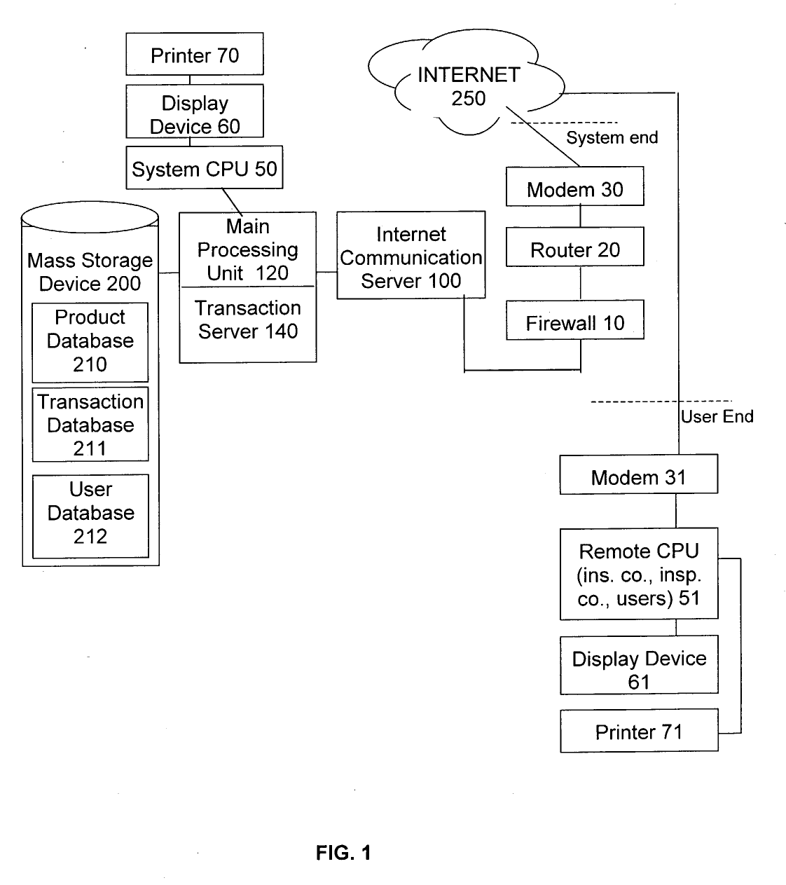

Referring now to FIG. 1, the primary elements of the computer network architecture of the system of the present invention in a preferred embodiment are depicted in the form of a block diagram. The system exchanges data with a plurality of remote terminals via known methods utilized for Internet communications, namely, data transmission across telephone and data transmission lines. Data transmission on the system end utilizes a gateway that interfaces the system to remote terminals with a protocol understood by said remote terminals or intermediary equipment connected thereto. For example, in a preferred embodiment of the present system, data is transmitted to and from the system via the Internet using transmission control protocol/Internet protocol (“TCP/IP”).

As depicted in FIG. 1, the system of the present invention in a preferred embodiment comprises an Internet Web communications server 100 communicating with consumers as well as with the other system-side components, said system-side components further comprising a mass storage device 200 having, in a preferred embodiment, a product database 210, transaction database 211 and user database 212, and a main processing unit 120 with a transaction server 140. The system may also include the use of routers 20 and firewalls 10 for creation of secure private communications networks between the system and users.

The product database 210 is a searchable relational database containing various categories of product data resident preferably in a structured query language (“SQL”) server. The SQL is programmed to allow searching of the database based on consumer specified criteria. The system provides a searchable product database 210 with graphical representation of the products and other product information. The product database 210 suitably comprises a set of merchandise specific information, which might be arranged in a variety of ways, such as, for example sequential entries preferably categorized by type of product, with each entry specific to a particular piece of merchandise. An entry for a particular piece of merchandise would include the store's item identifier, such as a Stock Keeping Unit (SKU) number, a Universal Product Code (UPC) number, or the like.

Each particular merchandise item entry further includes an item category field, typically implemented as a text string which identifies a particular food group category to which the item might belong; meats, vegetables, dairy products, fruit, and the like. A product name or item information field is also implemented as a text string and identifies the brand or trade name of the product and might also include a generic description of the product, i.e., KLEENEX.RTM., facial tissues.

In addition to the bar code data, food group category and product name, each merchandise item entry further includes a price field which might be further subdivided into an item price portion which contains the item price and a price comparison portion which contains an item's price-per-unit. Weights and measures fields are associated to each merchandise item and define an item's weight as well as an item's volumetric capacity (an item's size). An environmental grouping field is also preferably implemented as a text string or symbol and defines the environment in which that particular merchandise item needs to be stored, i.e., in the freezer, refrigerator or at room temperature.

The transaction server 140 in the preferred embodiment of the present system described in FIG. 1 comprises a central processing unit 120 and associated read-only memory connected along data and address bus lines to a random access memory and to the product database 210. The transaction server 140 may also have internal transaction data storage capability or alternately transaction data may be stored in a separate storage device. These components are operatively connected to commonly used input/output (“I/O”) interface devices that control various corresponding I/O devices. These I/O devices may include such conventional elements as a video display, a keyboard, a printer, a mouse and a digitizer or scanner.

As with other computer systems, the read-only memory of the transaction server 140 provides software instructions to enable said transaction server to execute necessary software applications programs performing the system functions, including control/interfacing with the system Internet Web communications server 100, communications with consumer remote terminals 51, links to third party websites where system advertisements are placed, database management, searching and updating; controlling event-driven algorithms through which the system processes transactions appropriately based on the directions indicated by consumer action (“events”) such as pressing keys or clicking a mouse; graphical presentation applications to produce online depictions of actual products identified from the product database 210 as fitting a customer's specified criteria; purchase order and other documentation generators. Other optional applications include data encryption/decryption and electronic signature generation and authentication applications, as well as electronic payment applications.

The website of the present system established by the Internet Web communications server 100 in a preferred embodiment is operatively connected to the Internet 250 and has at least a first home page remotely accessible by consumers. Under the present system, first time consumers will preferably access the system in response to a generic advertisement placed on another website, and then enter a query screen rather than a home page screen. Alternately, consumers may access the website of the present system directly and view the website homepage for options that can be selected to proceed into the system.

The system-end main processing unit 120 also includes processor means operating under one or more software applications configured to host the system Internet web pages, host and maintain the system product inventory control and host and maintain a multiplicity of consumer selection and purchase transactions. The processor correlates certain personal data input by a consumer through communication I/O means, with a virtual shopping basket containing the various products which that particular consumer wishes to purchase.

Connectivity between the user-end portion and the system may be effected in various forms without violating the scope and spirit of the present invention. In particular, system connectivity may be made by a telephone line/modem combination as is well known in the art, a dedicated ISDN line or a cable modem-type set-top-box which provides for Internet connectivity through certain forms of cable television services. In each of the aforementioned cases, the computer of the user-end portion will need to be provided with a suitable I/O card, such as a modem, ISDN card, and the like, in order to effect an appropriate interface with the system connection.

System Screens

The following sections describe key features of the system's graphical user interface.

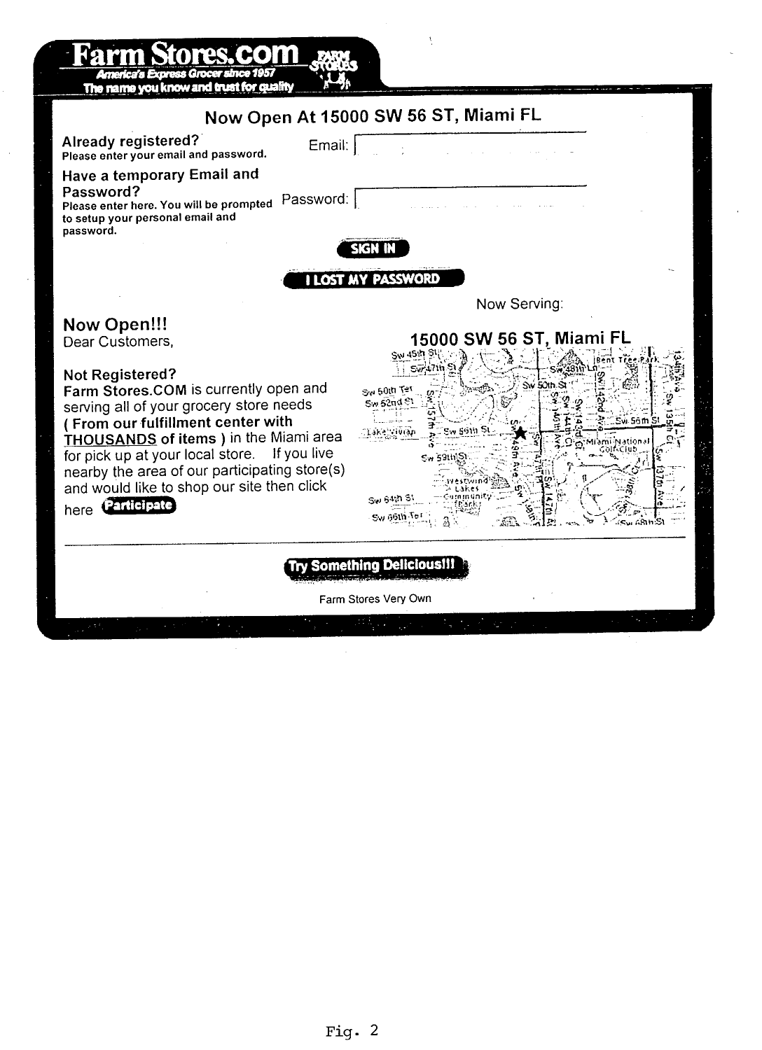

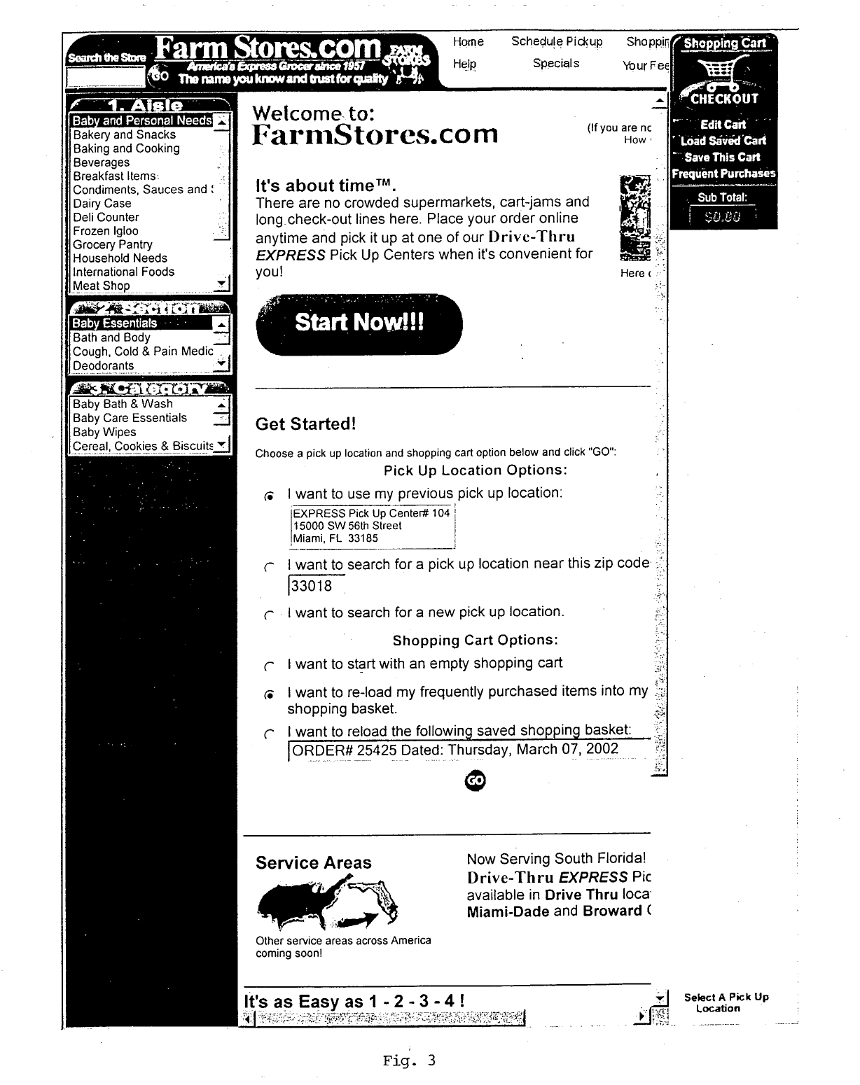

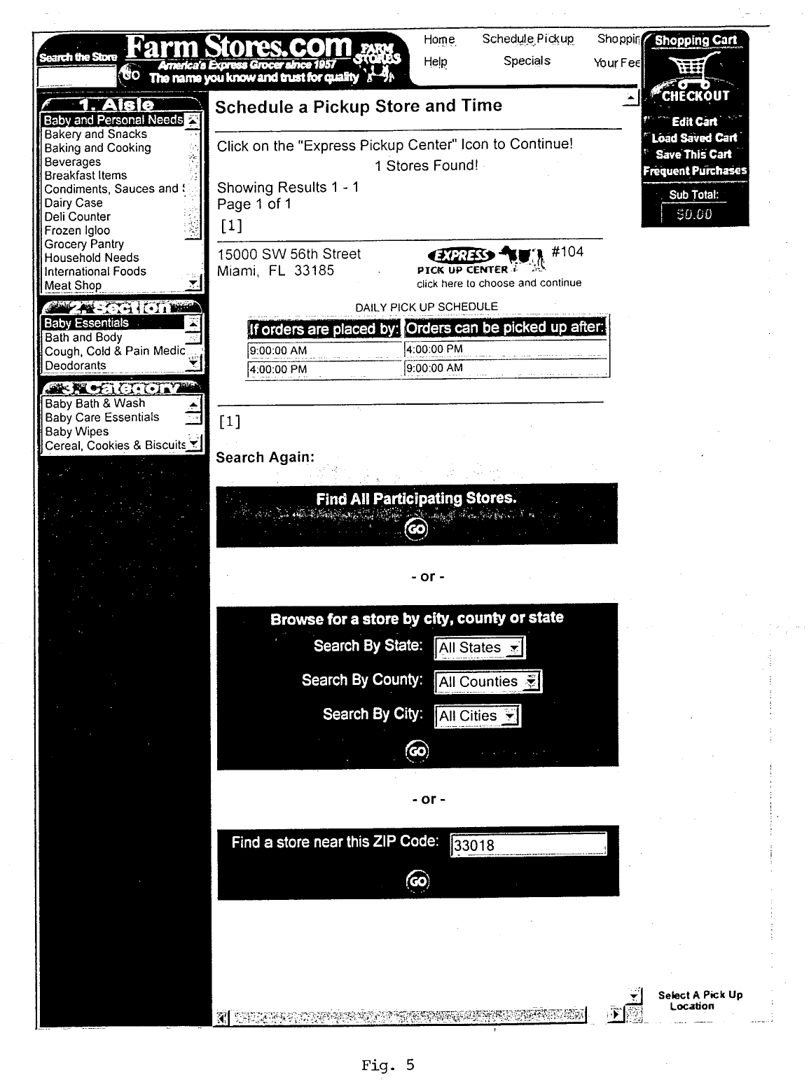

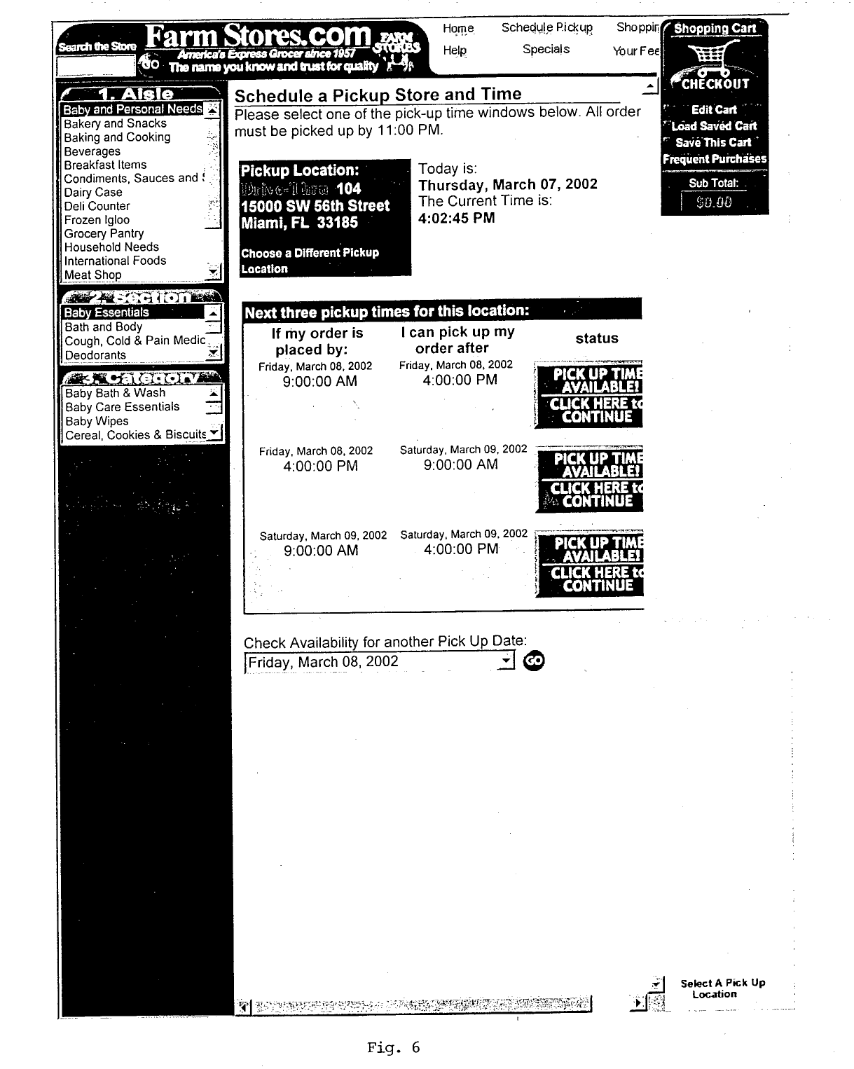

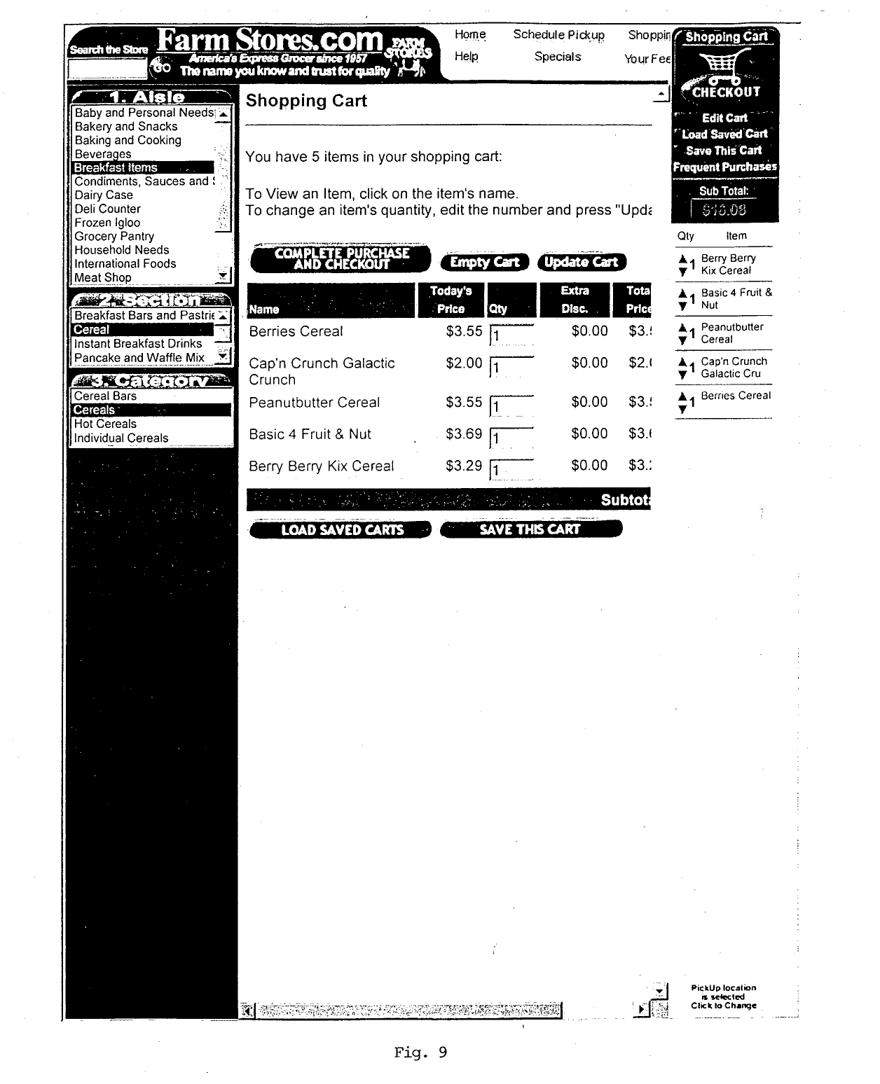

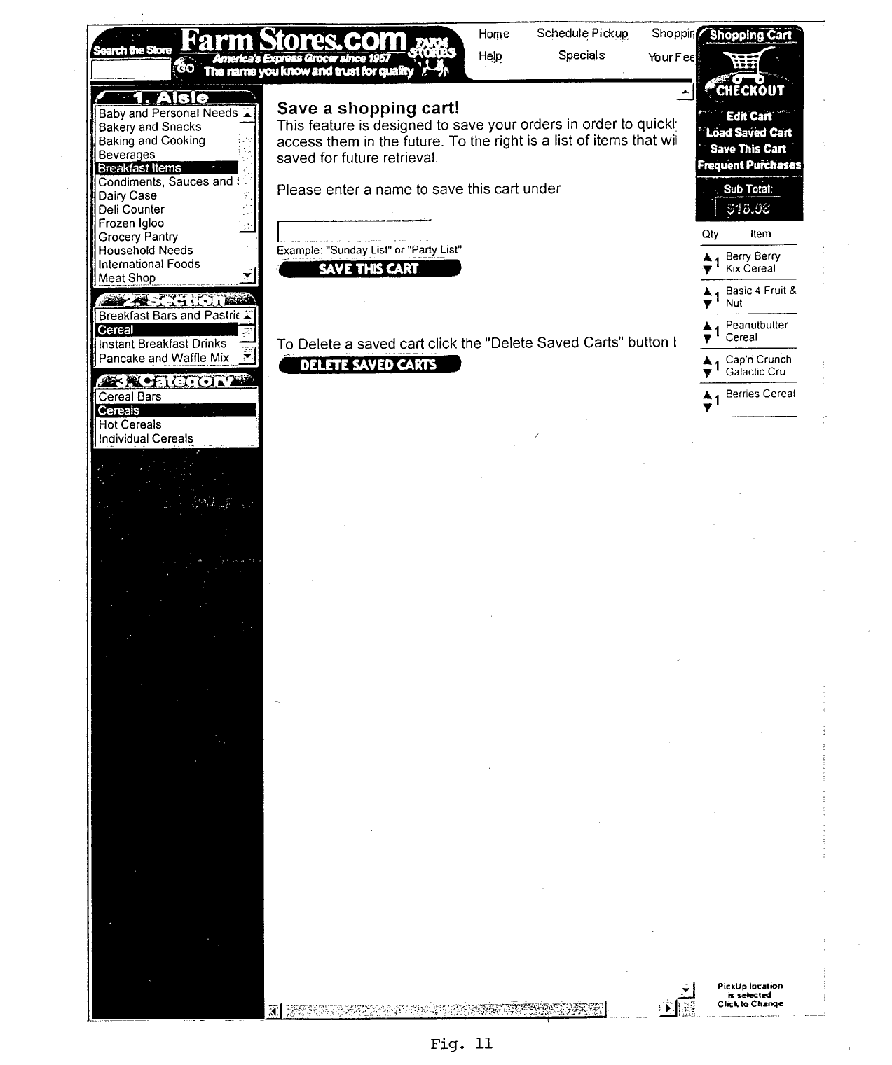

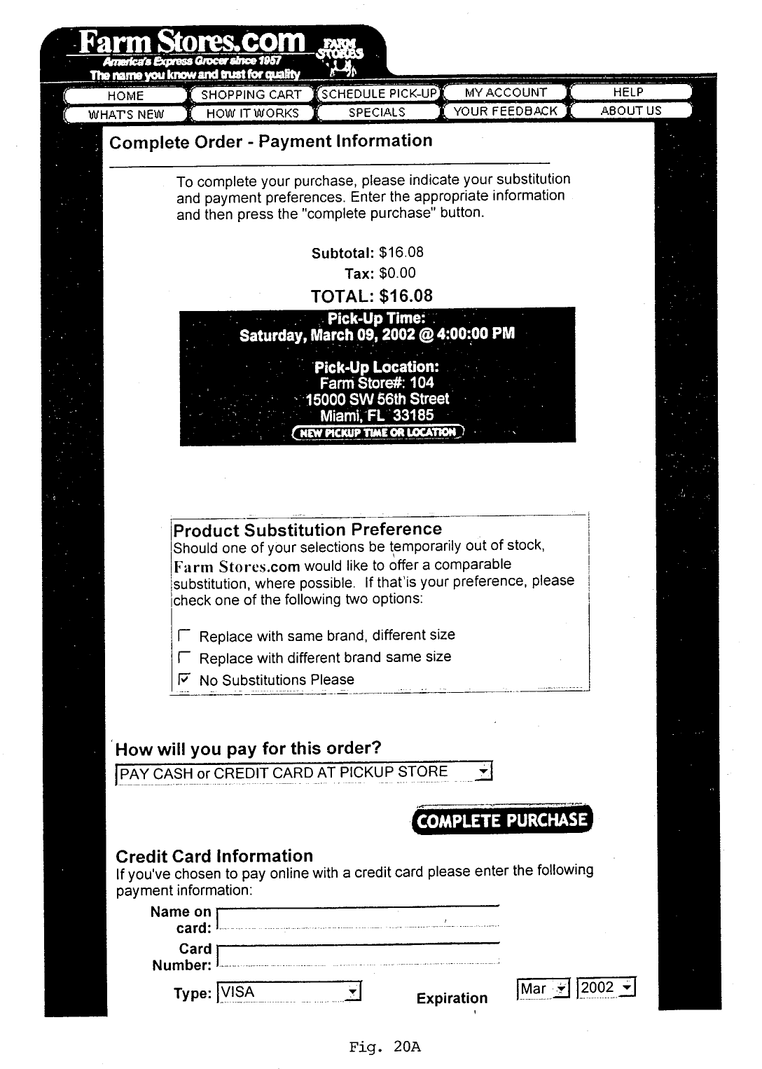

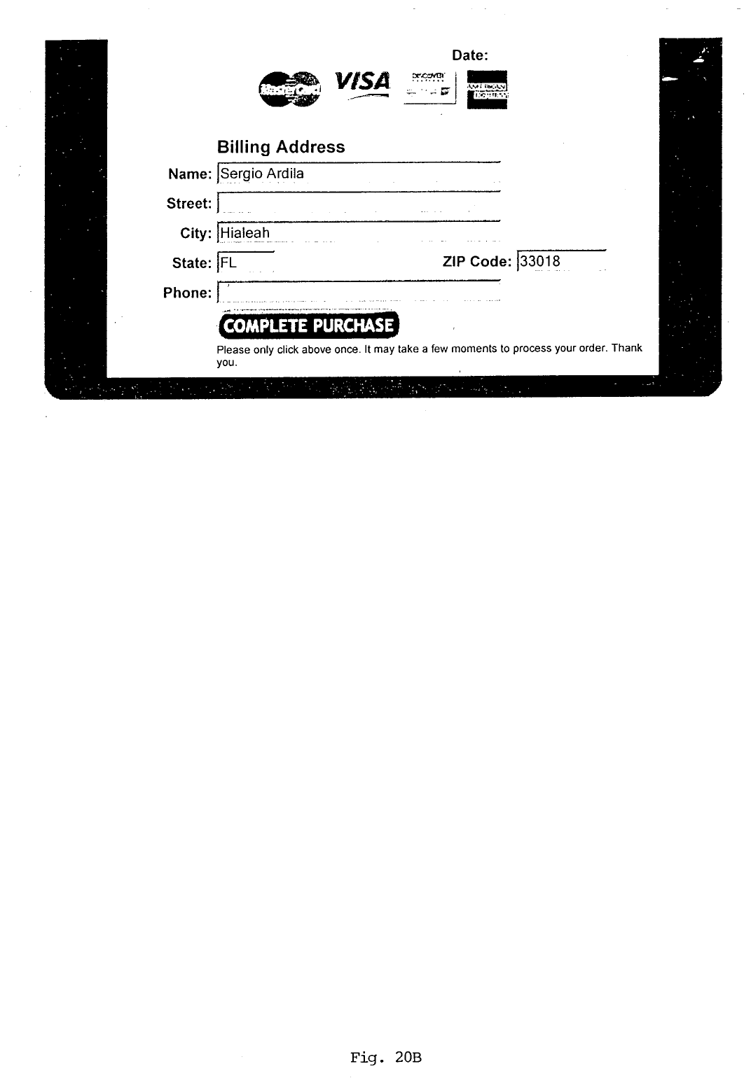

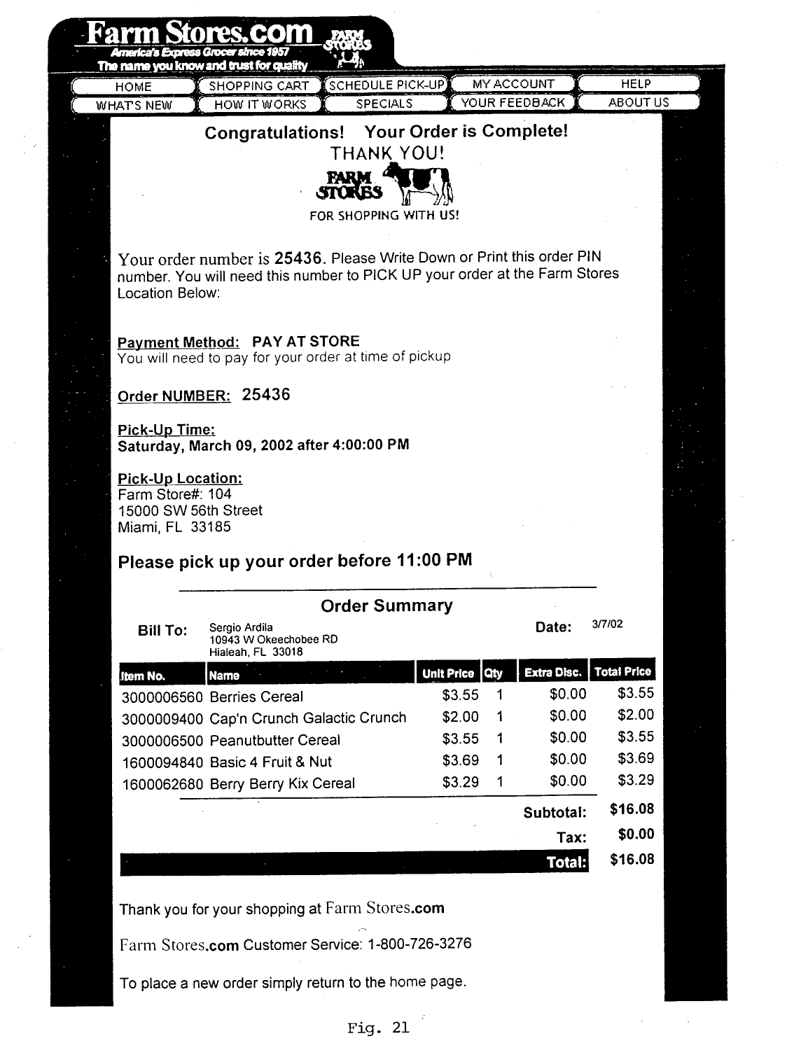

FIGS. 2-22 depict sample system website screens.

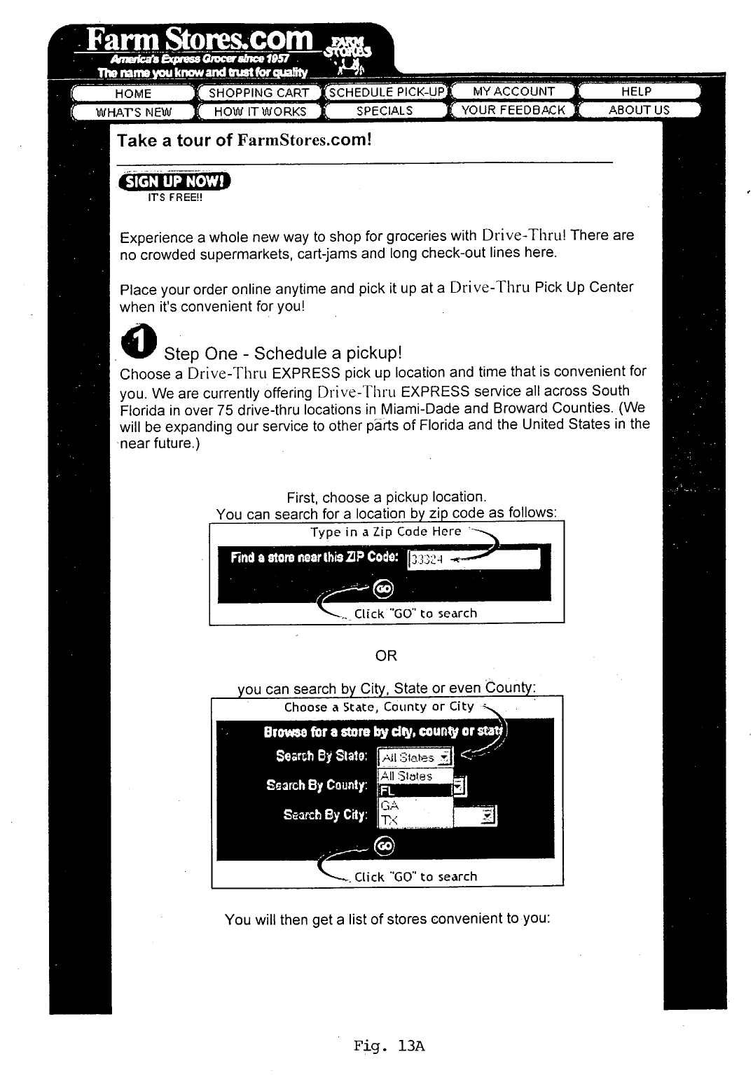

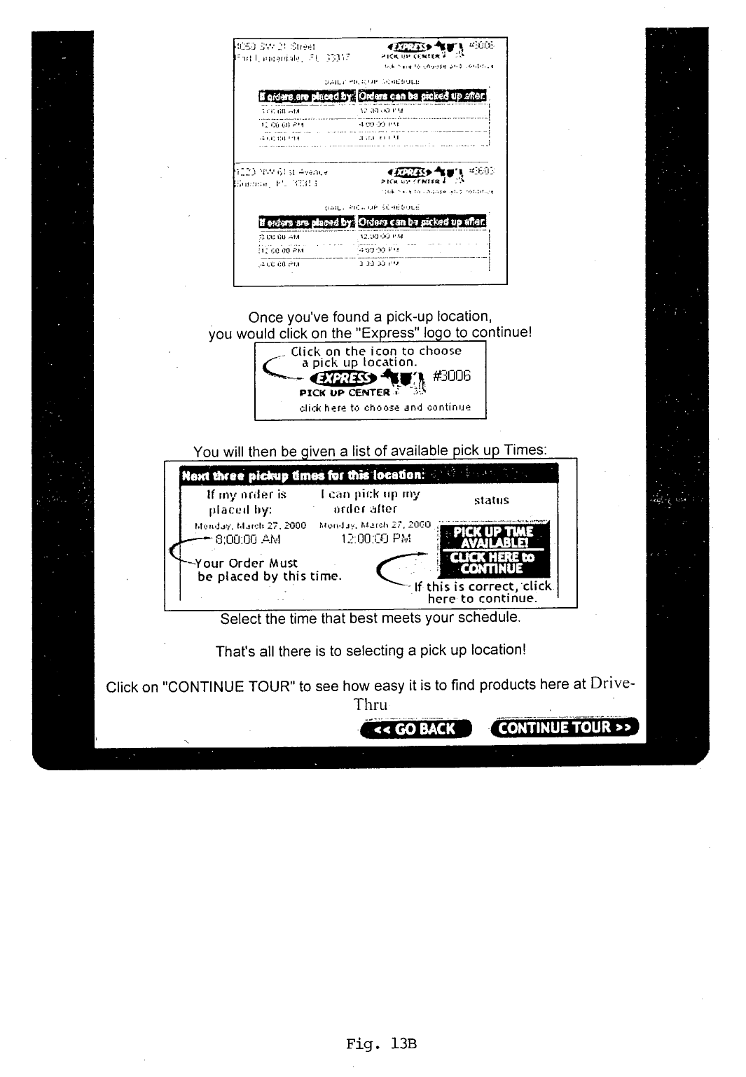

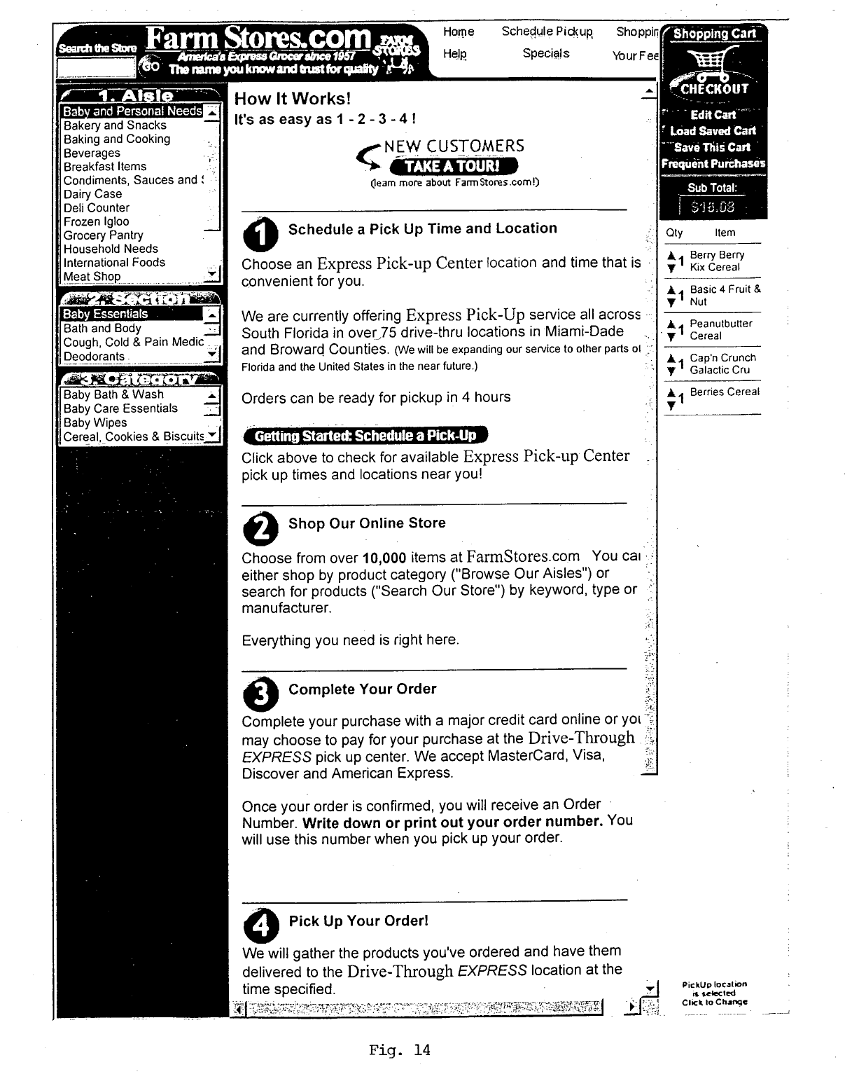

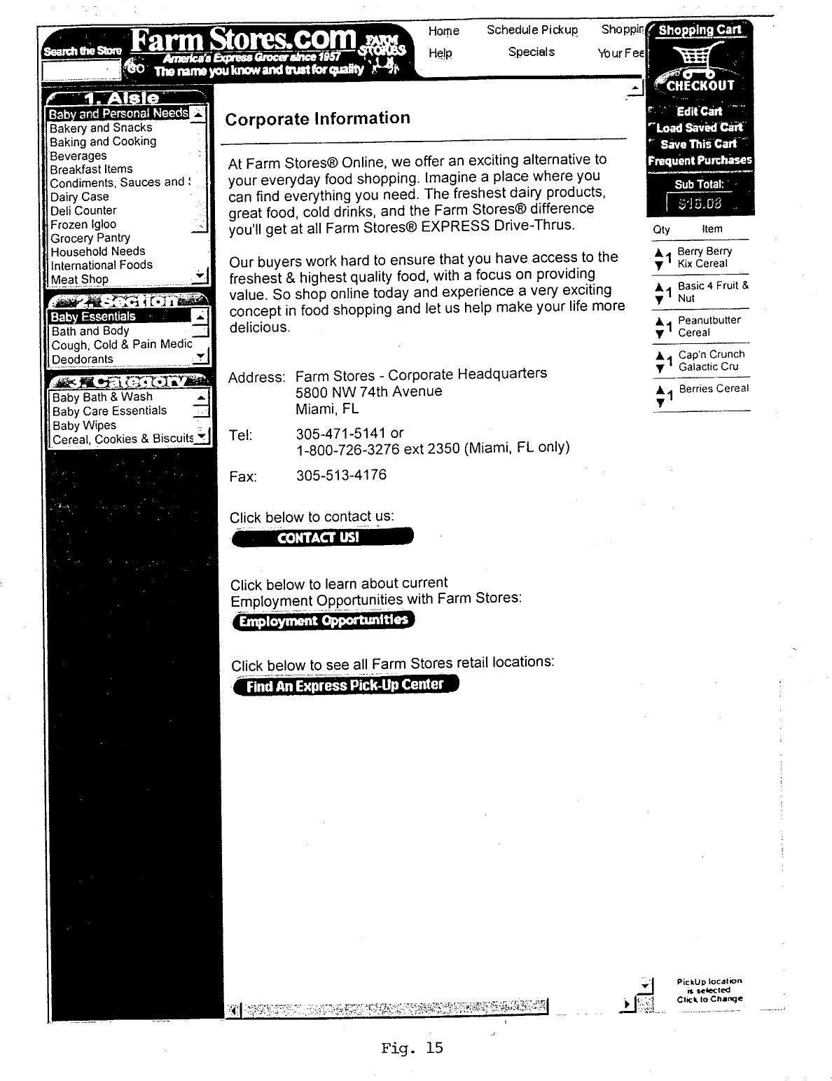

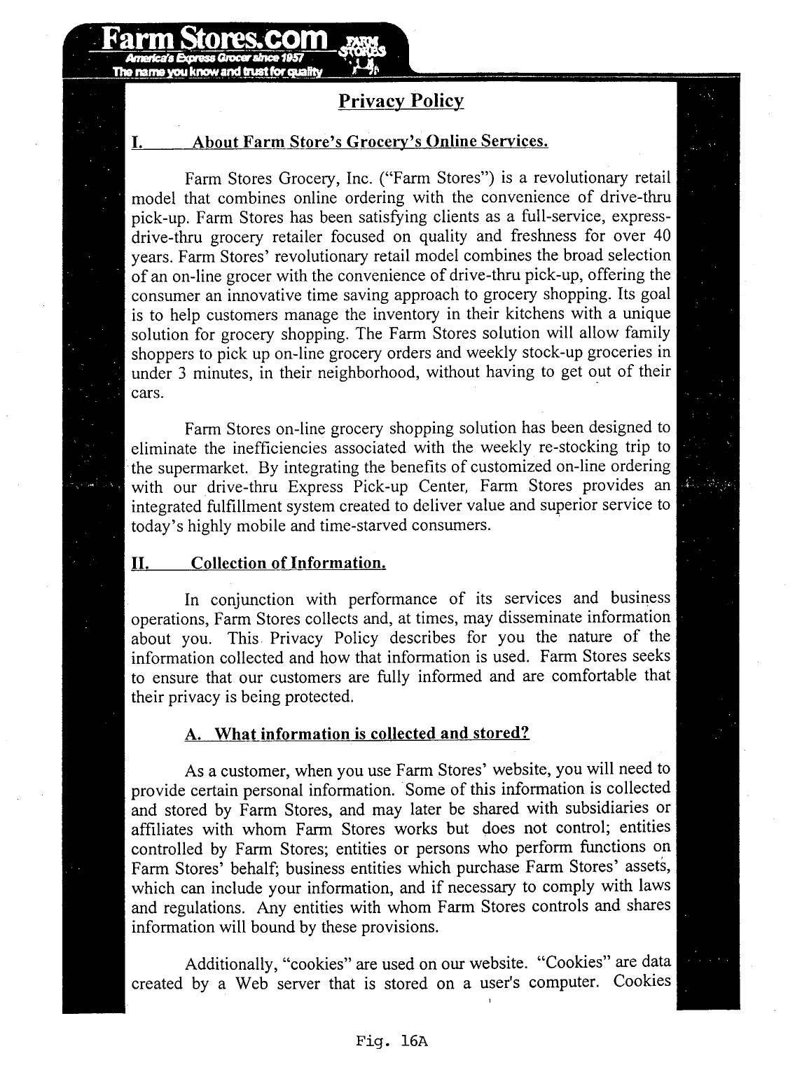

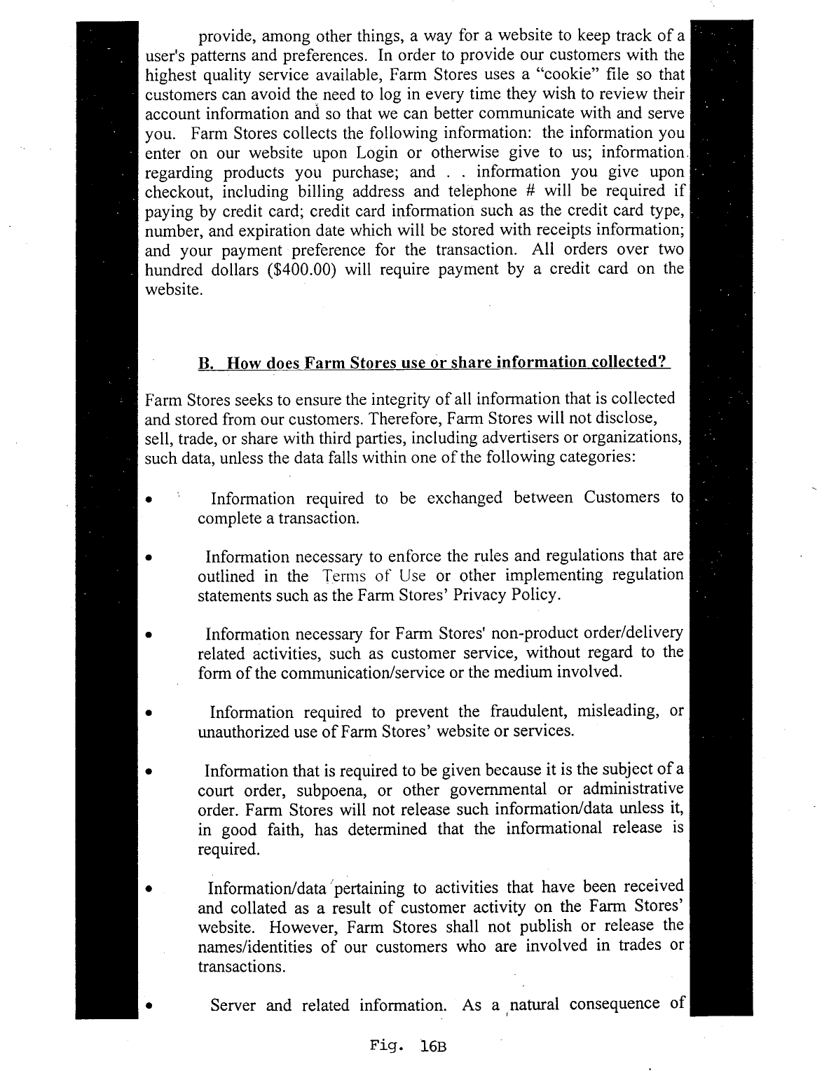

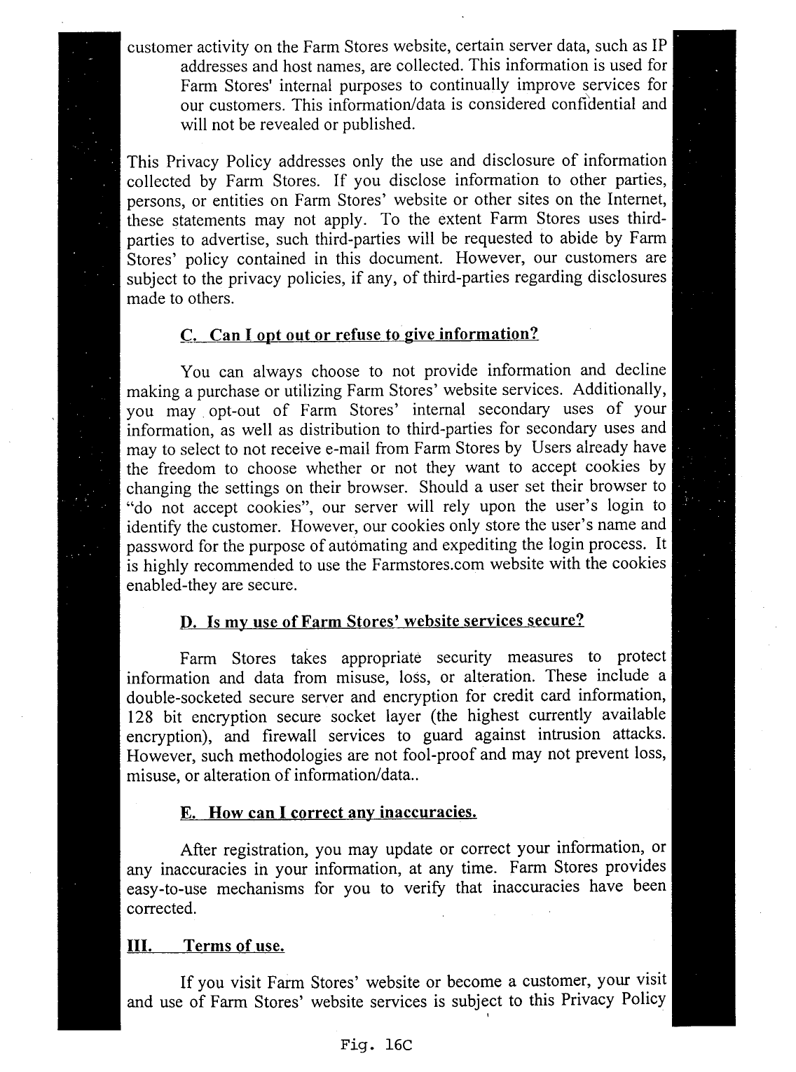

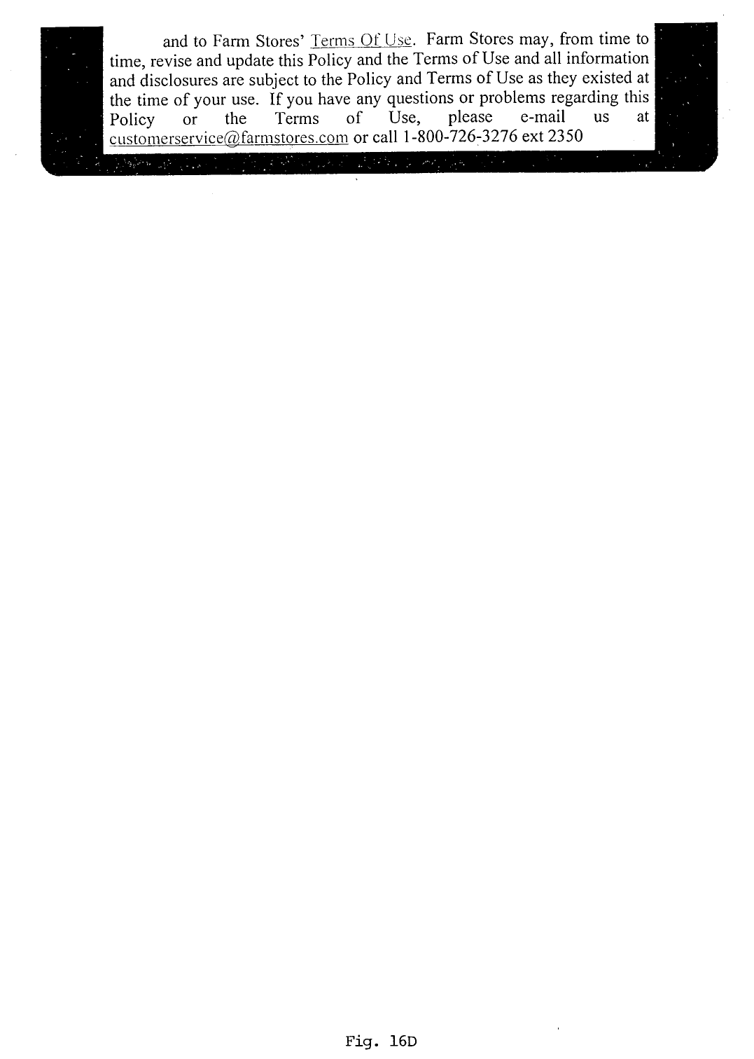

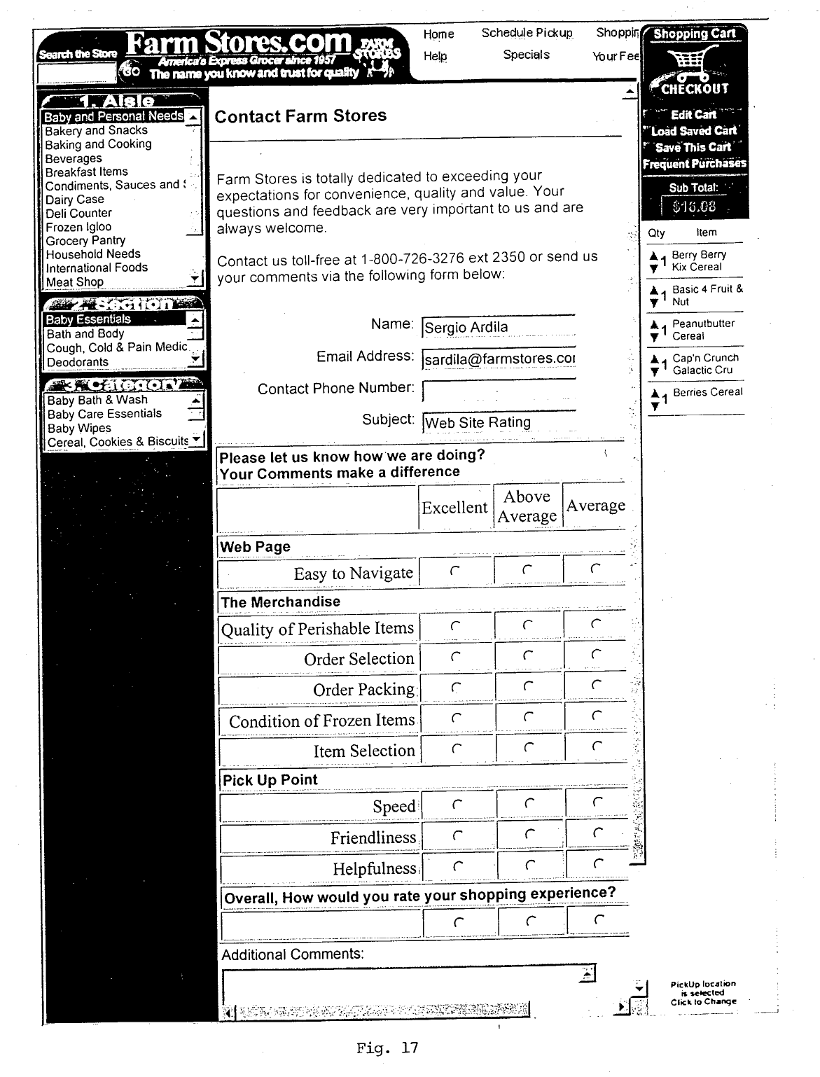

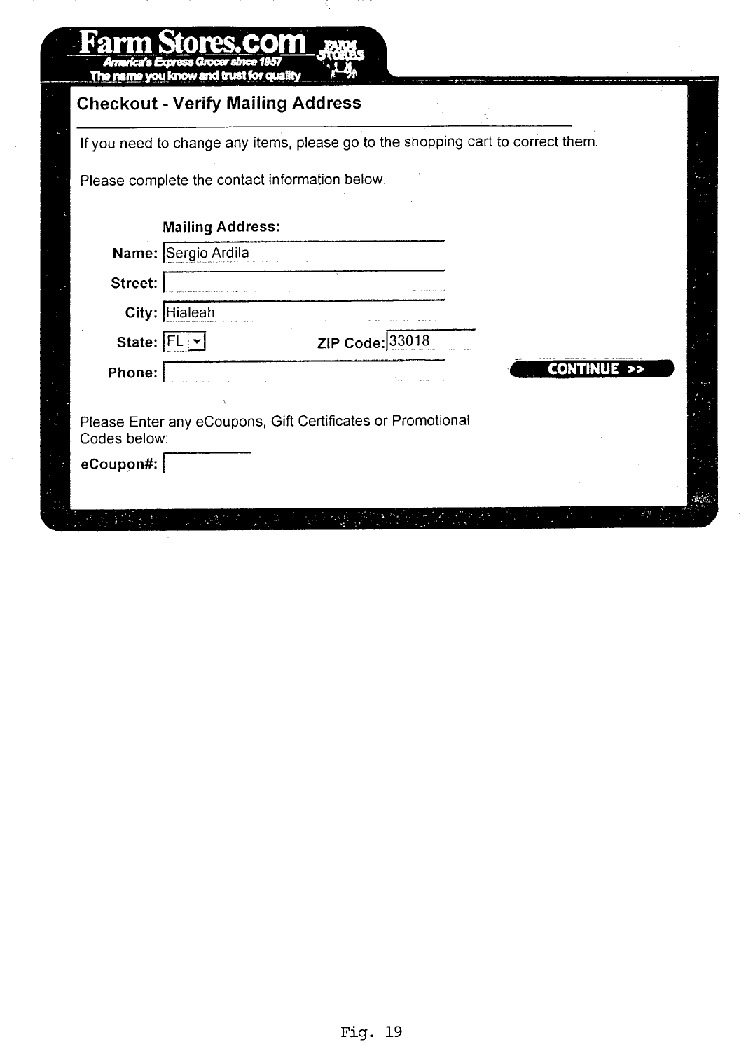

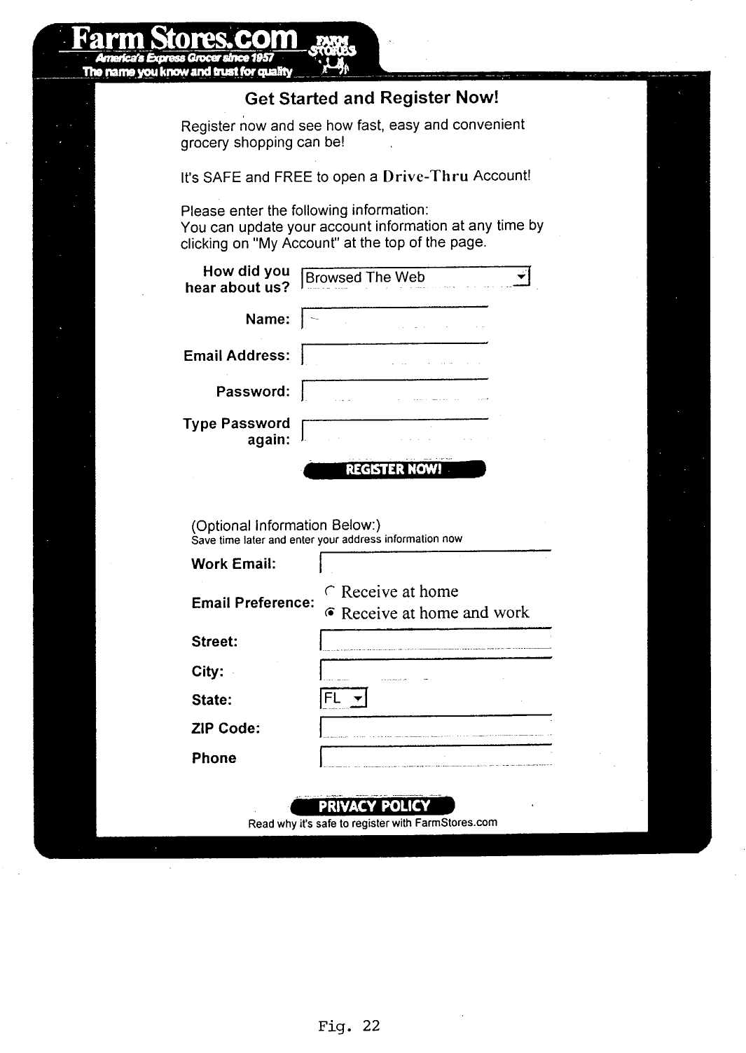

FIG. 2 depicts a sample user login screen. Registered users are prompted to sign in by entering their user password. New users can take a tour of the system website, as depicted in FIGS. 13a-b. User can also view a “How it Works” system usage information tutorial as depicted in FIG. 14, and can review system privacy and usage terms as depicted in FIGS. 16a-d. System operator corporate information and feedback submission is also facilitated as depicted in FIGS. 19 and 17, respectively. Those wishing to register to become system users would register by completing an online registration such as that depicted in FIG. 22.

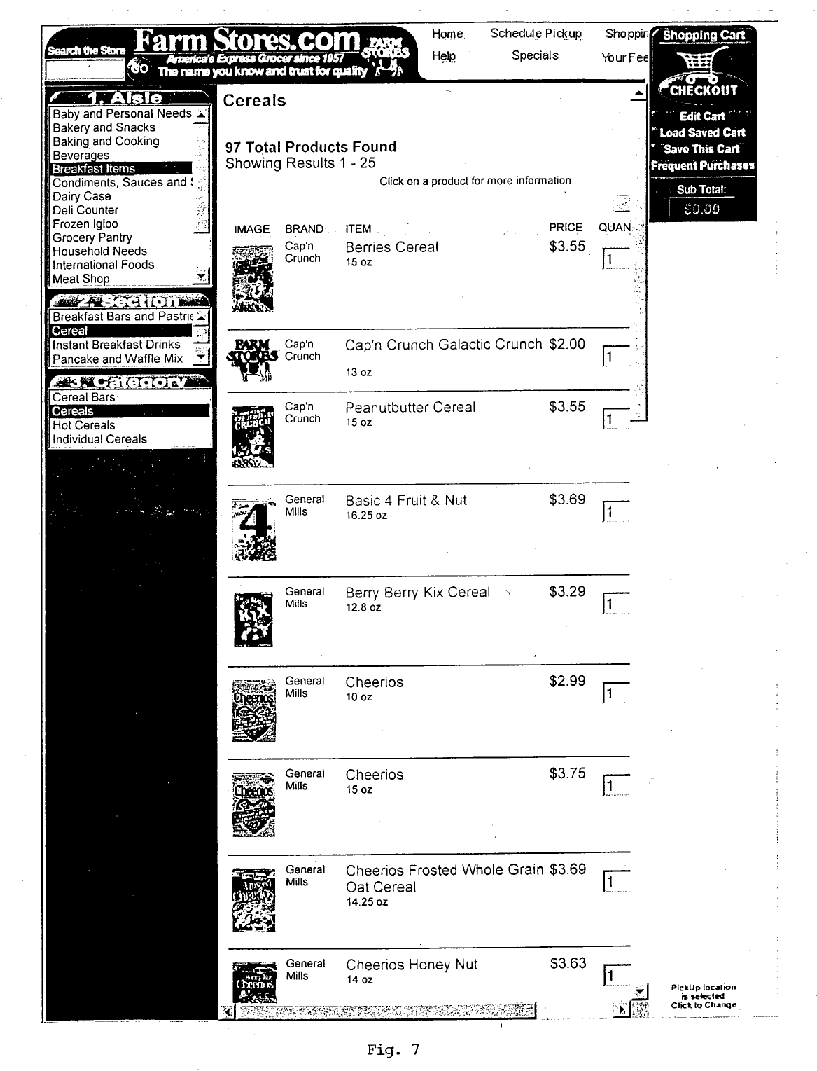

Referring to FIG. 7 which depicts a sample product information screen, a single click takes shoppers to a list of the products within each category. Most products are accompanied by a color photograph of the item. The “select” button places the item in the shopper's online shopping cart for today's order or on one of the customer's personal shopping lists for stock-up ordering. The goal is to permit a shopper to order these items in less than 10 minutes.

The Main Homepage or Storefront

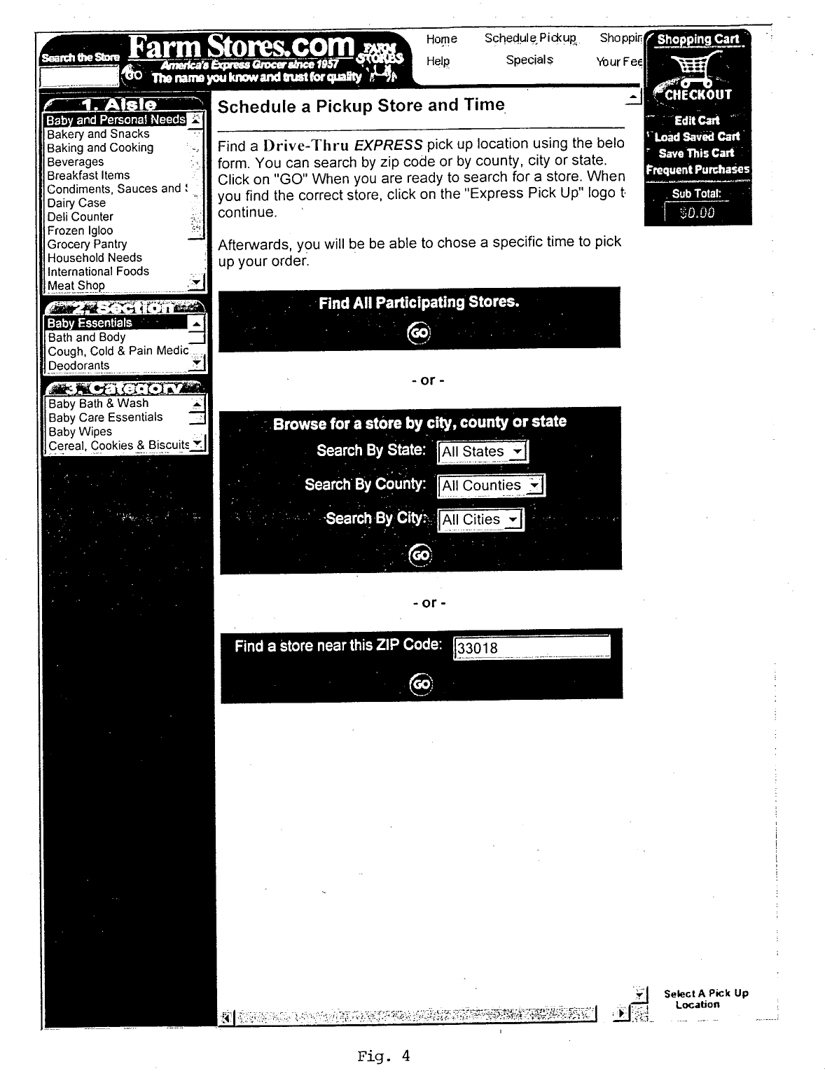

Referring to FIG. 3 which depicts a sample system home screen, whereby customers can retrieve their personalized grocery shopping list, browse through the product categories or quickly find specific products by name using a product finder feature and select a pick-up time slot and location. As new products are added, they are featured in the “What Is New” section. Brief instructions to help new customers get started can also be found on the main page or by directly accessing the system's “Help” section. Throughout the entire shopping experience, the “virtual” shopping cart accompanies the customer. The customer can always see the total of the order, plus quickly access shopping lists directly from the cart. All key commands are accessible from every website page. The system website provides top quality digital pictures of our products. Customers can elect not to display the product images to shorten the loading time of the web pages on their PC.

Finding Products

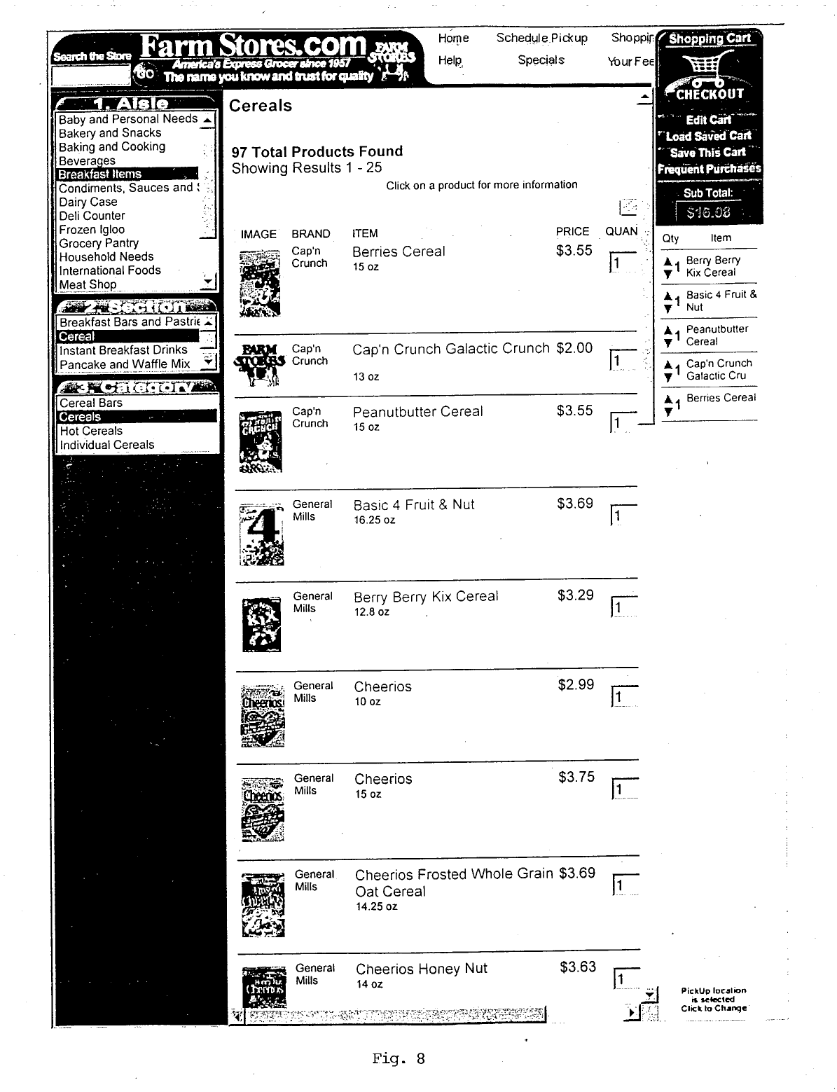

Referring to FIGS. 7-8, finding products in the system's virtual store is easy and quick. Customers may choose to browse through categories—similar to walking through the aisles of a store—or use the “Search” feature to find the items directly. This functionality significantly shortens customer “browse time” through a long list of products by conveniently “jumping” directly to the sections that they wish to see.

Personalized Grocery Lists

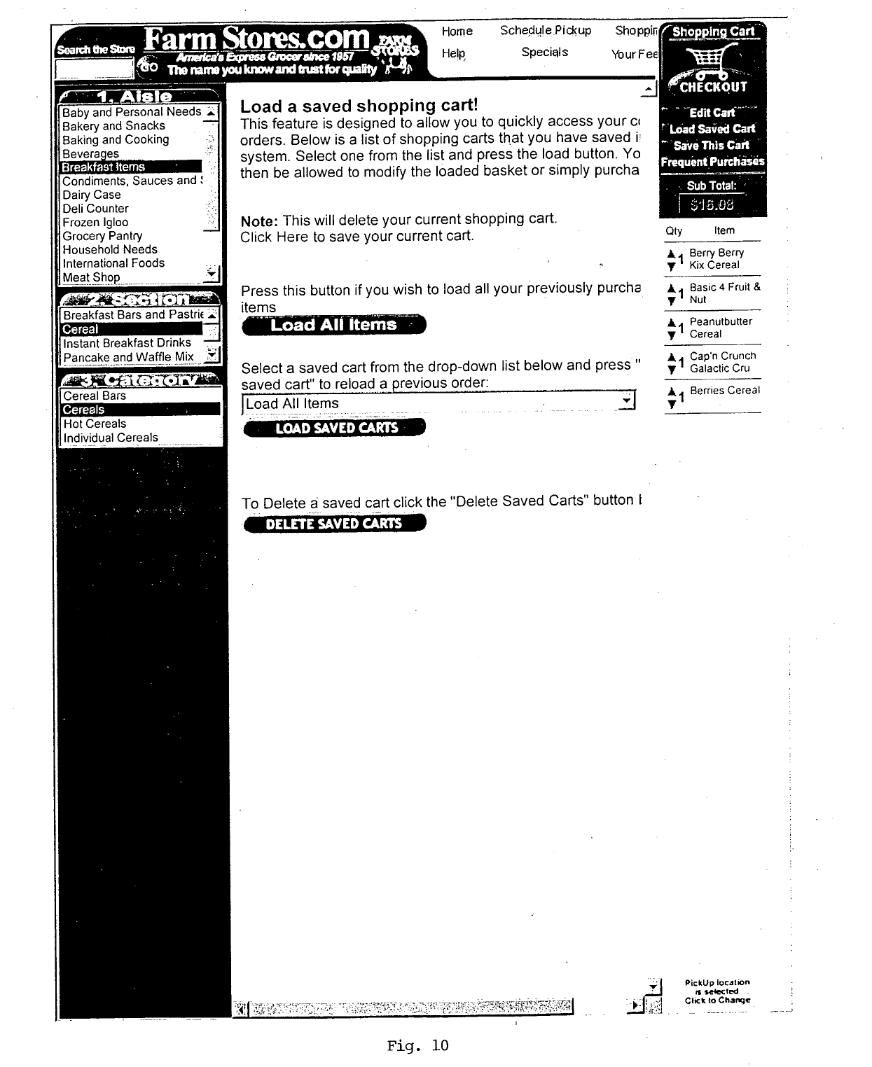

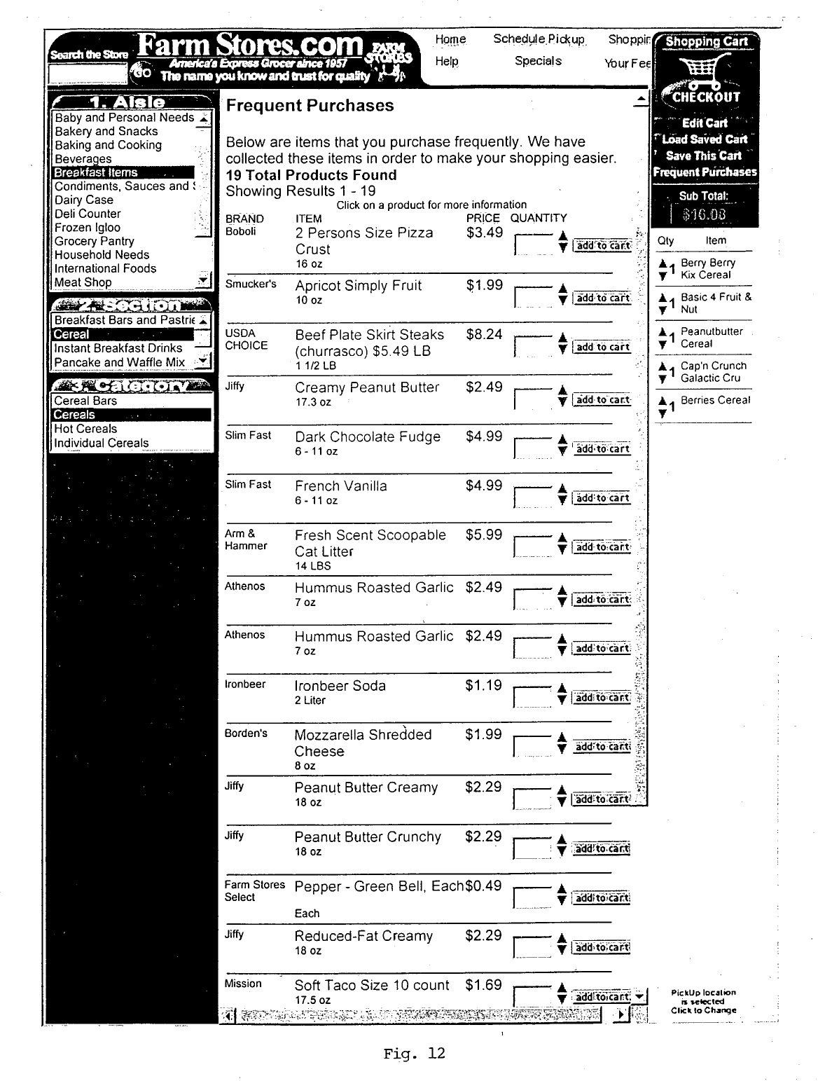

Referring to FIG. 3, a key to the system's ease of ordering is personalized shopping lists, which the customer can prepare in advance and use over and over again. For example, they can select items for their “My Favorites” list. Referring to FIGS. 10-12 which depict shopping cart list loading, saving and frequents purchase data screen the customer can also set up a list of items they order every week, every two weeks, every four weeks and every other month. With a few clicks they can edit each list for the current order or combine the lists. Creating these lists is simple with the “key word” search feature and browsing tools. It's also easy to add to a list. Personalized lists can easily be retrieved by clicking “Retrieve a List.” A sample “load a saved shopping cart” screen is depicted in FIG. 10. For customers wishing to fill their cart by reviewing recent orders, the system's virtual store automatically monitors the products purchased on their last four orders as a re-stocking reference. This list is easily accessed by clicking on “Frequent Purchases” as depicted in FIG. 12. The system will also track each customer's purchases and monitor what a customer should have at home and what they will need. If a product is not ordered that the system think should be ordered, it will ask the customer whether they want to add it to their “shopping cart.”

Specials

The system's “Specials” page offers customers the convenience of finding all specials on one page, rather than browsing through the aisles. Each product is displayed with high quality digital images. In the future, customers do not even need to visit the website to see a list of specials; the web server automatically sends information on specials via email to customers who have previously shopped at the website (if the customer opts to be on the e-mailing list).

The present invention is also a method for providing drive-through customer pick-up of grocery orders at multiple remote locations as selected by the customer, comprising the following steps: Providing an Internet website accessible by customers and including a searchable grocery product database and a grocery ordering transaction server and database through which customers accessing said database can search for and select for purchase grocery items and can search for and select one or more drive through pick-up stores and dates and times for customer pick-up of grocery orders placed through said website, processing customer grocery orders placed through said website by transmitting same to one or more grocery order fulfillment centers where grocery orders are packaged and loaded on to delivery vehicles based on the environmental storage requirements applicable to the ordered products and the designated drive through pick-up store location specified by the customer in said order, delivering grocery product orders from said fulfillment centers to the drive-through pick-up store location(s) designated by the ordering customer in advance of said customer's designated pick-up date and time, and loading the ordered groceries onto said customer's vehicle after said customer arrives at said designated pick-up store location and has paid for the ordered groceries.

Pick-up Convenience

Referring to FIGS. 4-6, there are several ways to locate a convenient store online to schedule a pick-up. Pick-up is totally drive through, with the customer waiting in his/her vehicle while the order is loaded onto the customer's vehicle. The system provides a unique feature in that because of the customers can find a store by entering their zip code, city, county or state. The system offers daily pick-up schedules, including weekends, at all express market pick-up store locations. Many stores are open 24 hours a day, seven days a week.

The system site allows customers to place their orders for pickup with as little as seven hours lead-time:

Place order by 9 am and pick up after 4 pm, the same day

Place order after 9 am and pick-up the next day

Because of the remote product inventory at the remote express market pick-up stores, customers can make additional “last minute” purchases on site while having their order loaded onto their vehicle.

Payment Flexibility

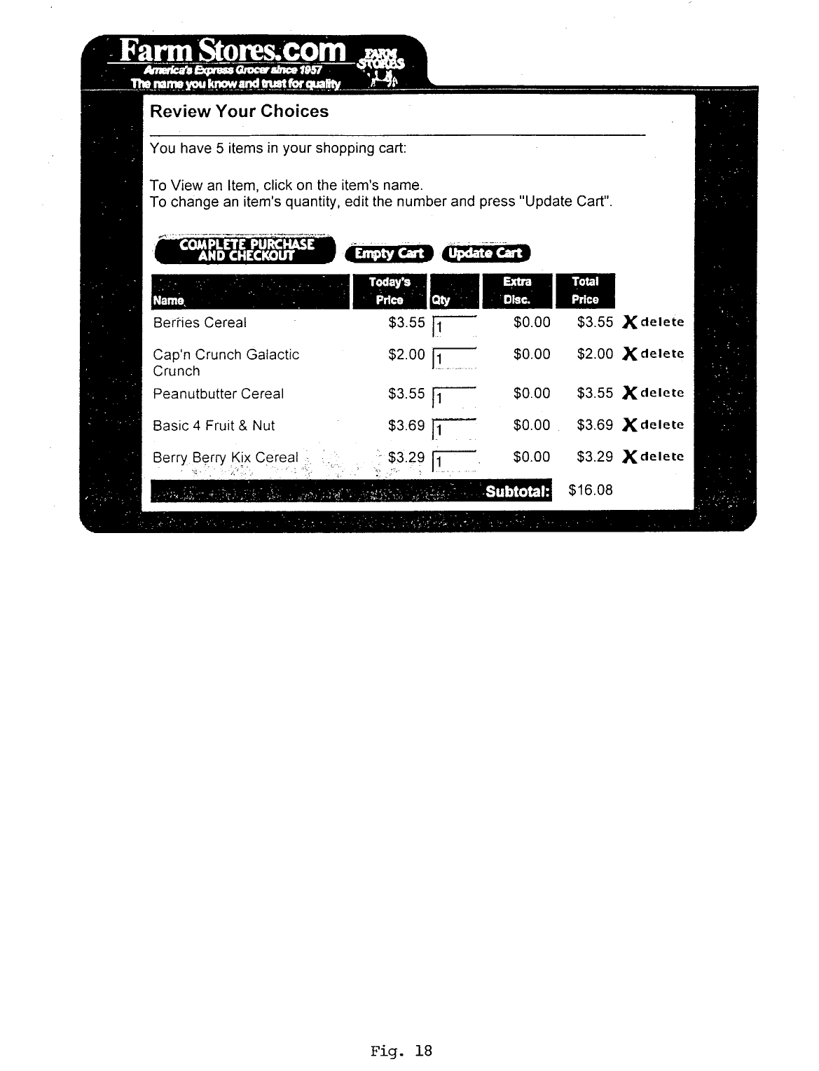

Referring to FIGS. 18-21, easy checkout means that customers have the choice of using their credit cards online or with cash, debit or credit cards when they collect their orders at any of the express market pick-up stores located within their geographical proximity. This unique flexibility provides a means for accepting orders from a broader range of customers.

Customer Privacy and Security

FIG. 16 depicts a sample system privacy policy screen. All customer-specific information is held in total confidentiality and will not be used in any manner not previously consented to by the customer. The system uses the VeriSign privacy program in a preferred embodiment. Online transactions of credit cards are protected by the widely used and reliable SSL 128-bit encryption method.

Reliability

The design of the virtual store offers unequaled convenience. The web store recognizes when a shopping session has been interrupted and automatically reloads at the last instance before the interruption occurred so that customer's shopping carts are not lost due to interrupted Internet connections on their home computers.

Help and Corporate Information

Referring to FIGS. 14 and 15, customers who wish to inquire about a certain feature can find detailed instructions on the help page, which has a comprehensive set of instructions on how to use the website features. Customers can also find out more information about the system operator or about employment opportunities by visiting the corporate information page. An online “Suggestion” page allows customers to provide the system operators with valuable feedback. Comments submitted by the customers are directly recorded at the web server for corporate review.

The system, in a preferred embodiment, utilizes pre-fabricated express market pick-up stores as described and claimed in U.S. Pat. No. 5,727,352 issued on Mar. 17, 1998 to an affiliate of the inventor of the present invention, the disclosure of which is incorporated herein by reference, which enables the cost-effectiveness, simplicity, and scalability.

Hub-and-Spoke Product Distribution Model

The system uses existing supermarkets as the “hubs” of its hub-and-spoke distribution model, combining the system fulfillment center hub with the express market pick-up store “spokes” for the economic advantages that they represent in terms of efficient operational and product logistics costs. The system's intuitive, user-friendly design gives customers a wide range of choices that allow them to quickly fill their shopping carts by retrieving their personalized grocery lists or choosing from standard lists of products conveniently grouped by category.

The system's model combines the supermarket hub with the neighborhood express market pick-up store “spokes” to create a cost-effective network with close geographic proximity to customers. The cost-effectiveness of the network allows the system to offer grocery items at comparable costs to landed grocers but already picked and packed for customers' pick-up, with the order filled, delivered to the designated express market pick-up location in accordance with the system's logistical scheduling software applications such that the order is delivered near the estimated time of pick-up, stored in environmentally appropriate containers and loaded onto customer vehicles when the customer arrives at the express market pick up store location. The cost-effectiveness of the “hub and spoke” drive-through pick-up model also eliminates significant costs incurred by home delivery models.

Highly Efficient Distribution System

Industry analysts recognize the high transportation costs of grocery home delivery. Delivery costs per customer can fluctuate based on a number of factors including the number of stops per route, order size, attended vs. unattended deliveries, and numerous other environmental factors. Delivery costs have forced other online grocers to add delivery fees in the range of $7-$10 to orders that are less than $50 to $60.

One of the key strategic advantages of the system's operating model is the significantly lower distribution costs associated with each customer order. This is accomplished by using a loop route system with scheduled stops between a fulfillment center and its designated express market pick-up stores, delivering multiple customer orders per stop.

One to two times each day, express market pick-up stores receive scheduled deliveries of fulfillment center customer online and off-line orders. Deliveries of customer orders are made in temperature-controlled vans and scheduled ahead of the corresponding customer pick-up time window. This system scheduling software minimizes the transit and “store-residency” time of the fulfillment center. At the same time, the load factor, or capacity utilization, of the delivery vehicle is maximized. Due to the close proximity of express market pick-up stores to each other, delivery couriers make numerous stops per day at each location. Under the system's model, one preferred embodiment resulted in distribution costs per customer of less than $2.00, while current home delivery costs are typically more than $20 per stop.

The system's distribution solution offers a significant cost benefit over the inefficient one-stop-per-customer-order delivery model, and it provides a viable “last mile” alternative to the incremental transportation and labor costs that pose a serious logistics challenge for grocery home delivery. The truly predictable distribution schedule facilitates the system's ability to offer customers same-day order fulfillment. With order lead times as short as four hours in an exemplary embodiment, customers may pull up to their neighborhood express market pickup store, where their fulfillment center totes are quickly retrieved and placed in the trunk of their cars, allowing them to drive off in typically under three minutes.

Product Selection

The system's virtual store offers customers a selection of all the items they usually stock up on. This includes thousands of popular non-perishable grocery items as well as hundreds of the most popular perishables including dairy, ice cream, meat, and produce. The product offering consists of major national brands in the dominant sizes. The system's category management process adjusts the virtual store's product selection by market area.

Handling

The customer is given his or her order in new sealable, transparent bags. Bag transparency helps customers rapidly inspect products if they choose and thereby ensures that the system maintains rapid drive-through service. Bags are stored and transported in plastic totes, some of which are insulated for refrigerated and frozen products.

In addition to the previously-described virtual store technology that has been developed to provide an efficient and personalized online shopping solution, the system integrates the entire fulfillment process—from the customer, the fulfillment center, and the express market pick-up store, to the route planning and scheduling system.

Express market pick-up stores are furnished with electronic point-of-sale (“POS”) registers and back-office systems such as, in a preferred embodiment, those supplied by the TEC America Corporation. TEC has a long-standing reputation as a leading supplier of high quality and reliable retail information systems and registers to the grocery industry. The TEC system features product scanning and scan receiving. Transaction data from the express market pick-up store is uploaded electronically to the system data center for processing.

All express market pick-up stores and their corresponding fulfillment centers are interconnected as part of a virtual private network (“VPN”) utilizing digital subscriber line (“DSL”) or wireless communication technology, as available. The VPN connectivity is utilized for online order tracking and reporting, e-mail, and providing a continuous video link to the express market pick-up store that is used for training, monitoring operational/customer service processes, and security.

Each fulfillment center is provided with warehouse management software that maximizes picking efficiency by consolidating orders, mapping out picking routes, and communicating with pickers with hands-free voice control devices. This application is integrated with the front end of the system as well as inventory management software and merchandizing software to ensure coordinated information flow that helps ensure customer satisfaction (product availability, product freshness, etc).

To ensure a secure and reliable operating environment, all system application servers are “collocated” in third-party facilities that feature advanced security, environmental controls and back-up power systems. All express market pick-up store systems are supported by a “24/7” (24-hour, 7-day) help desk staff that can assist in troubleshooting most situations or can dispatch technical at-store support from a network of certified dealers.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative and other embodiments may be selected without departing from the spirit and scope of the present invention.

What is claimed is:

1. An Internet-based grocery ordering system providing for drive-through customer pick-up of grocery orders at multiple remote locations as selected by the customer, comprising:
a customer-side computer configured for Internet access to communicate with the system server,
a system server providing an Internet communications interface with customers, further comprising a main processing unit and a mass storage device containing a searchable product database and a grocery purchase order transaction server and database for online grocery order intake and processing,
a grocery order fulfillment center communicating with said system server to receive and process customer orders and having one or more grocery product inventory management and order fulfillment management software applications to maximize fulfillment efficiency,
one or more drive-through stores located at locations remote from said fulfillment center which are available for customers to select as the pick-up point for their grocery order,
means for delivering ordered products from said fulfillment center to said customer-designated drive-through market, and
means for loading the ordered groceries onto said customer's vehicle after said customer arrives at said designated pick up store location.

2. The system of claim 1, wherein said system server's mass storage device further includes a customer information database.

3. The system of claim 2, wherein said customer information database includes saved customer personalized shopping lists.

4. The system of claim 1, wherein said system server's searchable product database includes data regarding product item dimensions and suitable storage environments used by said grocery order fulfillment center to properly pack ordered grocery items.

5. The system of claim 2, wherein said customer information database includes data regarding customers' previous orders for tracking customer ordering habits and suggesting items that customers may need to re-order.

6. The system of claim 1, wherein said drive-through markets are interconnected in a virtual private communications network for online system order tracking and reporting.

7. The system of claim 1, further comprising means for customers to pay for their grocery orders via the system website as well as in person upon pickup of purchased groceries at customer's designated drive through pick up store location.

8. The system of claim 1, further comprising a loop route grocery order delivery system with regularly scheduled grocery order deliveries from fulfillment centers to multiple drive through pick up store locations in a preprogrammed sequence to maximize delivery efficiency.

9. A method for providing drive-through customer pick-up of grocery orders at multiple remote locations as selected by the customer, comprising the following steps:
providing an Internet website accessible by customers and including a searchable grocery product database and a grocery ordering transaction server and database through which customers accessing said database can search for and select for purchase grocery items and can search for and select one or more drive through pick-up stores and dates and times for customer pick-up of grocery orders placed through said website,
processing customer grocery orders placed through said website by transmitting same to one or more grocery order fulfillment centers where grocery orders are packaged and loaded on to delivery vehicles based on the environmental storage requirements applicable to the ordered products and the designated drive through pick-up store location specified by the customer in said order,
delivering grocery product orders from said fulfillment centers to the drive-through pick-up store location(s) designated by the ordering customer in advance of said customer's designated pick-up date and time, and
loading the ordered groceries onto said customer's vehicle after said customer arrives at said designated pick-up store location and has paid for the ordered groceries.
